(19) United States
(12) Patent Application Publication
(10) Pub. No.: US 2018/0206128 A1
(43) Pub. Date: Jul. 19, 2018

(54) METHODS AND APPARATUSES FOR DETERMINING AN EQUIVALENT CELL IN A COMMUNICATIONS NETWORK

(71) Applicant: NOKIA SOLUTIONS AND NETWORKS OY, Espoo (FI)

(72) Inventors: Eva PEREZ, Munich (DE); Christian MARKWART, Munich (DE)

(21) Appl. No.: 15/744,231

(22) PCT Filed: Jul. 11, 2016
(86) PCT No.: PCT/EP2016/066385

§ 371 Date: Jan. 12, 2018

(51) Int. Cl. H04W 16/14; H04W 64/00; H04W 16/18

(52) U.S. Cl. CPC H04W 16/14; H04W 84/045; H04W 16/18; H04W 64/00

(57) ABSTRACT

A method and apparatus for a communications network comprises obtaining a property from one or more cells of the network, and determining an equivalent cell equivalent to the one or more cells using the property.

### FIELD OF THE INVENTION

The present invention generally relates to a method and apparatus for a communications network. More particularly, the invention relates to spectrum sharing in a radio access network (RAN).

### BACKGROUND OF THE INVENTION

In a radio access network (RAN) consisting of base stations (Macro, Pico and Femto cells), the base stations or cells can be enabled to use spectrum sharing to extend the capacity for broadband wireless access.

In addition to licensed and license-exempt (unlicensed) authorization methods, new spectrum sharing concepts such as Licensed Shared Access (LSA) or co-primary spectrum sharing have been discussed as ways of providing additional capacity to mobile networks (see for example EU RSPG: Report on Collective Use of Spectrum (CUS) and other spectrum sharing approaches RSPG11-392).

Independently from the authorization methods, new spectrum management approaches are required to meet the growing requirements for flexible spectrum whenever needed.

Licensed Shared Access (LSA) spectrum is an example of such a new flexible spectrum support approach. The spectrum is owned by an Incumbent (primary user), who allows other licensed operators to use this spectrum for their required purpose.

LSA allows support of different operators by using separated LSA spectrum resources. Each LSA spectrum resource is defined by a spectrum, a location where this spectrum is used, and a time frame when the spectrum is used at the defined location.

In mobile networks, spectrum utilization and allocation is performed via static configurations based on network planning data of a Mobile Network Operator (MNO). With the introduction of LSA it is no longer possible to stay with these static configurations because the LSA spectrum needs to be evacuated according to predefined terms and conditions if requested by the incumbent (spectrum owner). The principle of “my spectrum, my usage” will not hold any longer. In other words the well known static spectrum allocation methods need to be complemented, which leads to a paradigm change in the mobile communication industry.

In addition to the traditional exclusive spectrum assignment, there is also a new method “spectrum resource pooling” in which (in some regions) certain parts of the spectrum may no longer be exclusively assigned to a single operator but jointly assigned to several operators with the obligation to use it collectively.

In new spectrum sharing scenarios, such as LSA with spectrum resource pooling, it is required to support a defined level of quality of service (QoS) whenever the shared spectrum resources are used by the spectrum sharing partners. A key feature of QoS is the avoidance of interference between the spectrum users. This is typically performed by a respective spectrum management system, for example an LSA Repository, which decides if a spectrum resource is available for a sharing partner or not.

However, with the introduction of small cells to a network, especially when they are deployed in an uncoordinated way, it can become difficult for a spectrum management system to decide whether or not such a cell interferes with another cell of another sharing partner. To overcome this problem, the spectrum manager needs to know how the propagation of each cell will look like. This requires detailed information about the location, configuration of transmitter and antenna parameters for each cell. On the one hand, the amount of information to be exchanged increases considerably, with the numbers of cells and when the network contains for example self management features to optimize cell edge behaviour. This can lead to a significant increase in network traffic. In addition, details of network data, such as configurations and optimization measures, are confidential and need to be protected. This is because knowledge of network data is of high value, especially for mobile network operators.

A solution is required that overcomes the problems outlined above: protection of network details, limiting the information exchange for dynamic networks containing multiple cells, and support of 3GPP self management features for cell interference optimizations between cells in the primary user's own network and cooperating networks.

Even though cognitive radio techniques have been known for a quite a long time, LSA is the first spectrum sharing method that provides a predictable QoS for the shared spectrum. Planned extensions such as spectrum resource pooling generate additional problems that need to be solved before such methods receive a broader acceptance on the market. Other solutions have been discussed, such as TVWS sharing, which introduces a geo-location database GLDB. However, this typically requires a deep knowledge of the requesting device and the environment where the device is located before the GLDB is able to decide which spectrum and which constraints can be provided to a requesting device to avoid interference with neighboring devices.

The present invention has been devised with the foregoing in mind.

### SUMMARY OF THE INVENTION

Accordingly, the present invention provides a method for a communications network, the method comprises obtaining a property from one or more cells of the network, and determining an equivalent cell equivalent to the one or more cells using the property.

In this way, it can be determined whether a shared spectrum resource is able to be used by a potential spectrum sharing partner without disclosing sensitive network details or significantly increasing network traffic.

The property of the one or more cells can be mapped to the equivalent cell. Furthermore, several cells can be mapped to more than one equivalent cell. For example, eight small cells could be mapped to two equivalent cells.

The property can be obtained from an evaluation point in the one or more cells. Preferably as many evaluation points as possible should be used.

The property may include a user measurement at the evaluation point from each cell of the one or more cells of the network.

The user measurement can include location. Location may be calculated using, for example, triangulation according to signal strength, and/or timing advance methods.

Obtaining the property may comprise collecting the user measurement at the evaluation point from each cell.

Determining the equivalent cell may comprise interpolating the user measurement at the evaluation point from each cell. Preferably, user measurements shall be interpolated between as many evaluation points as possible.

Further, determining the equivalent cell may comprise estimating signal strength at the evaluation point according to a propagation model. The propagation model can be a standardized propagation model.

The propagation and interference can be determined by an Operator using the following methods:
1. Theoretical Calculation: Use configuration information of each cell (BTS) covering an area as input and calculate the signal strength at several locations inside the area for all cells/BTS or use a desired propagation as input and calculate respective configurations for each cell. This method simplifies the physical characteristics of the area. To overcome propagation and interference issues typically safety margins are added to the result.
2. Measurements: with respective measurements from multiple evaluation points at different locations (typical UEs with respective location information) it is possible to determine the real propagation of each cell covering the area. The accuracy of the result depends on the number of different evaluation points, because missing evaluation point measurements are interpolated. It is possible to use the shared spectrum (when it is assigned to and used by the Operator of the cells) or a neighbored spectrum with similar behavior (typically the neighbored spectrum is owned by the Operator and the propagation of the neighbored spectrum is available and the directly mapped to the shared spectrum.
3. Network Planning (=Combination of 1+2): The propagation is calculated as described in (1.). Additionally measurements from evaluation points (UE with known locations) as described in (2.) are used to increase the accuracy. Due to the combination of both methods a lower number of measurements is required to get a precise propagation and interference map

In an alternative example, determining may further comprise using a geometrical shape to describe interference of the equivalent cell.

In another example, obtaining the equivalent cell may further comprise finding a best fit between a geometric shape and an interference map obtained from the one or more cells of the network.

Characteristics which are interpreted as rules for neighboring and/or overlapping spectrum resources used by the sharing partners may be defined for the area inside and/or outside the geographical shape. For example other sharing partners can use neighbour spectrum resources as long as the maximum allowed interference level inside the shape is not violated (the maximum allowed interference level is such a characteristic).

The invention further provides a method for a communications network, which comprises obtaining an equivalent cell equivalent to one or more cells of the network, requesting a shared spectrum resource for the equivalent cell, and determining if the shared spectrum resource can be used by the equivalent cell by using the inside and outside characteristics of a geometrical shape representing the equivalent cellrequesting.

The spectrum manager determines if a shared spectrum resource is available to be used by the equivalent cell with respect to sharing rules that are defined for the sharing method (e.g. LSA) and the inside and outside characteristics of the geometrical shape representing the equivalent cell.

For example, each spectrum resource can be defined by a spectrum, a location where this spectrum is used, and a time frame when the spectrum is used at the defined location. The spectrum manager can search for an available spectrum channel that can be used by the equivalent cell for a specified time, and in case of a positive result, it blocks and protects the corresponding shared spectrum resource according to the provided in and outside characteristics defined for the geographical shape, so it will not be used by any other spectrum sharing partner (spectrum sharing partners are not aware of which spectrum resources are being used by the other partners).

If a shared spectrum resource is provided to an Operator A it cannot be used by another Operator B, i.e., this spectrum resource in the network looks to the other operators like a reserved zone, e.g. exclusion zone, protection zone, and/or restriction zone where the same spectrum cannot be used at the same time. In other words, only neighbouring and overlapping spectrum resources that fulfill, beside the sharing rules for the sharing method (e.g. LSA), the inside and outside characteristics defined for the geographical shape can be assigned then to other operators. This is for example a general rule for LSA to guarantee the QoS. Neighbouring/overlapping means either neighbouring/overlapping in time (a different time period) or a neighbouring/overlapping spectrum channel or a neighbouring/overlapping area.

The invention also provides a computer program product adapted to run on a processor, wherein the computer program product is configured to control the processor to perform the method of according to any examples of the invention described herein.

The invention also provides an apparatus for a communications network. The apparatus comprises a receiver configured to obtain a property from one or more cells of the network, and a processor configured use to the property to determine an equivalent cell equivalent to the one or more cells.

In one example, several cells can be mapped to more than one equivalent cell. For example, eight small cells could be mapped to two equivalent cells.

The receiver can be configured to receive the property from an evaluation point in the one or more cells. Preferably, as many evaluation points as possible should be used.

The receiver can be configured to receive a user measurement at the evaluation point from each cell of the one or more cells of the network.

The user measurement can include location.

The processor can be configured to determine the equivalent cell by interpolating the user measurement at the evaluation point from each cell.

Alternatively, the processor can be configured to determine the equivalent cell by estimating signal strength at the evaluation point according to a propagation model. The propagation model can be a standardized propagation model or based on calculations of signal strength in the network when in use by the primary user of the network.

The processor can also be configured to determine the equivalent cell by using a combination of interpolating the user measurement at the evaluation point from each cell and estimating signal strength at the evaluation point according to a propagation model.

In addition, the processor can be configured to determine the equivalent cell by using a geometrical shape to describe interference of the equivalent cell.

The processor can be further configured to determine respective rules for spectrum usage by using said geometrical shape.

In order to build the property or geometrical shape, which describes the interference from the group of cells, there are different options.

First, the measurements are collected (if any are available), which consist of the signal strength from each cell transmitting at the shared spectrum and reported from all users using the shared spectrum. These measurements (if they are available) are interpolated over evaluation points in order to build a complete propagation map.

Secondly, and independently of having measurements or not, considering information of the network (location of the cells, antenna parameters, transmit power, etc.) and according to a theoretical propagation model, the signal strength from each cell at each evaluation point is estimated. This may be the only option if there are not measurements available, for example, when the spectrum is used for the first time, and no users have yet used the spectrum.

Finally, the signal strength from the interpolation of the measurements, and from the estimation based on the propagation model is combined (estimation is used in areas where there are no users which report measurements). With the signal strength from all cells in the evaluation points, it will be possible to build a propagation map used to obtain the equivalent cell(s). When the spectrum is used for the first time, the propagation map will be very similar to the estimation from the theoretical model, whereas after using the spectrum for a long time, the propagation map will be more similar to that when measurements are available.

The apparatus can be a network entity. For example, the apparatus can be a mapping entity or a controller, such as an LSA controller.

The invention also provides an apparatus for a communications network. The apparatus comprises a receiver configured to obtain an equivalent cell equivalent to one or more cells of the network, a transmitter configured to request a shared spectrum resource for the equivalent cell, and a processor configured to determine if the shared spectrum resource can be used by the equivalent cell by using the inside and outside characteristics of a geometrical shape representing the equivalent cell.

The spectrum resource can be an LSA spectrum resource.

For example, each LSA spectrum resource can be defined by a spectrum, a location where this spectrum is used, and a time frame when the spectrum is used at the defined location. The spectrum manager can search for an available spectrum channel (and the corresponding spectrum resource) that can be used by the equivalent cell, and in case of a positive result, it blocks the corresponding resource, so it will not be used by any other spectrum sharing partner (spectrum sharing partners are not aware of which resources are being used by the other partners).

The receiver can be configured to obtain the equivalent cell from an interference environment of a shared spectrum resource.

The receiver can be further configured to obtain the equivalent cell by finding a best fit between the geometric shape and an interference map obtained from the one or more cells of the network.

The processor can be configured to determine an interference map for the equivalent cell.

In addition, the processor can be further configured to use the interference map in order to determine whether the shared spectrum resource would interfere with the spectrum sharing partner.

The apparatus can be a network entity. For example, the apparatus can be a mapping entity or a controller, such as an LSA controller.

The invention will now be described, by way of example only, with reference to specific embodiments, and to the accompanying drawings, in which:

### BRIEF DESCRIPTION OF THE DRAWINGS

FIG. 1 is a simplified schematic diagram of a method for checking whether or not a shared spectrum resource is available at the location of the requesting network entity;

FIG. 2 is a simplified schematic diagram of a network entity according to one example of the invention;

FIG. 3 shows a method according to one example of the invention;

FIG. 4 shows a method according to one example of the invention;

FIG. 5 is a simplified schematic diagram of a radio access network;

FIG. 6 is a simplified schematic diagram of an equivalent cell;

FIG. 7 shows a method according to one example of the invention;

FIG. 8 shows an interference map from cells of a network;

FIG. 9 shows an interference map from cells of a network; and

FIG. 10 is a simplified schematic diagram of a network entity and associated interfaces according to one example of the invention.

### DESCRIPTION

The invention describes a method for a network resource sharing environment that allows network information protection and self management for a defined number of entities forming this network with a parallel reduction of information exchange to an administration function that manages the shared network resources for this and other networks.

Dynamic spectrum sharing scenarios, where spectrum resources are used by multiple sharing partners, are based on a central function that manages the spectrum resources in a way that the spectrum efficiency is maximized in an area over the time. Typically such a central function has to follow regulatory rules to protect and/or restrict spectrum users in various ways, e.g. country border restrictions, fairness rules between the sharing partners, protection of spectrum owners, and technology related regulations.

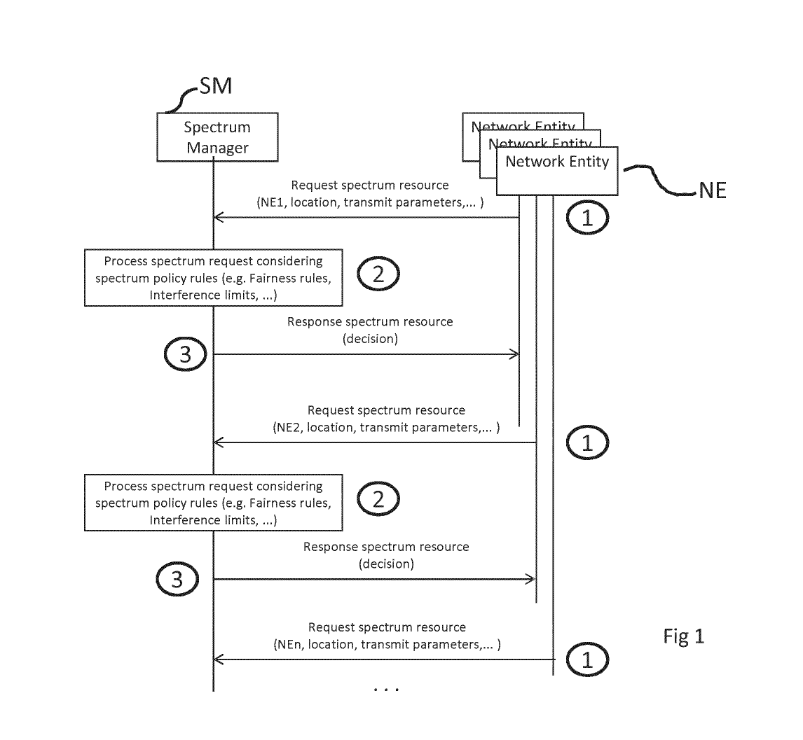

Current concepts require that each single network entity NE has to provide a defined set of information to the central function (Spectrum Manager), which uses the data to check whether or not a shared spectrum resource is available at the location of the requesting network entity. FIG. 1 shows an example of this principle with the 3 steps that are performed for each Network Entity NE.

The Spectrum Manager SM also has to perform fairness rules, which require that a spectrum resource needs to be evacuated in a first operator network to provide the spectrum resource to another requesting second operator network. Such actions generate additional traffic at the interface to the Spectrum Manager SM, especially when the first operator network includes multiple cells. Multiple cells are typically deployed in a way that these cells provide full coverage in a given area. As mentioned above, network operators are not willing to provide sensitive data as configuration and location of cells to other parties operating the Spectrum Manager SM.

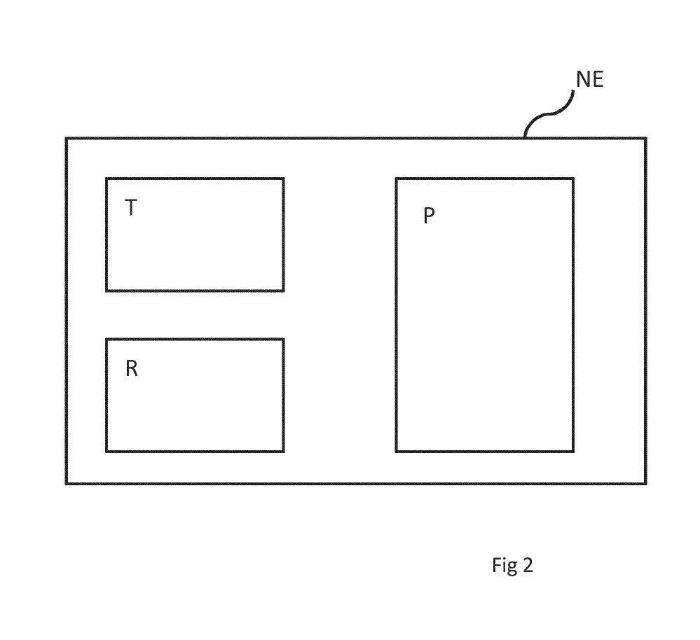

FIG. 2 schematically shows a network entity NE according to one example. The network entity NE is part of a radio access network (RAN) and can be, for example, a controller, a mapping controller or an LSA controller. The network entity NE includes a receiver R, a transmitter T and a processor P. The receiver R can obtain various information or properties, such as user measurements, from one or more cells of the network.

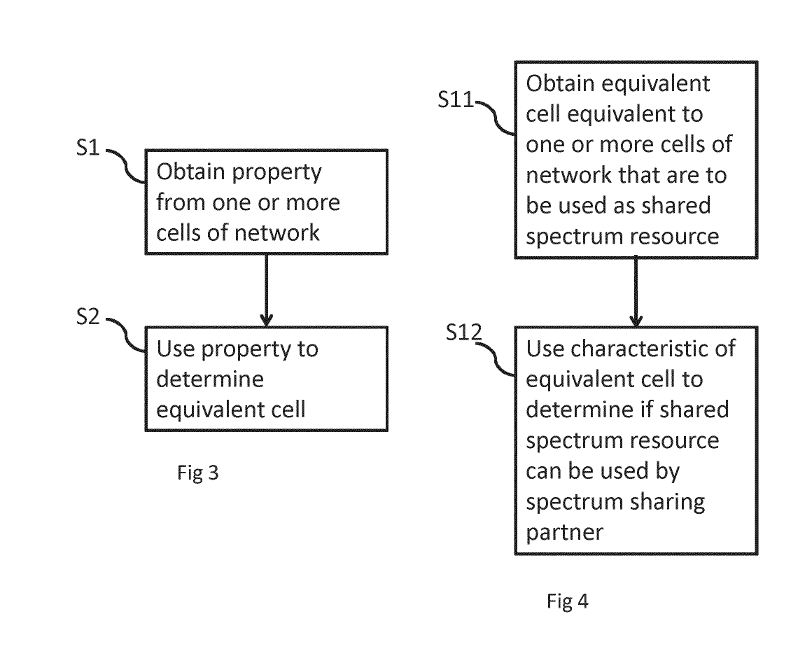

In one example, shown in FIG. 3, the receiver obtains a property from one or more cells of the network in step S1 and in step S2 the processor P uses this property or properties to determine an equivalent cell, which is equivalent to the one or more cells in the network. The receiver can receive this property from an evaluation point or points located in one or more of the cells. For example, a user measurement can be received from each evaluation point, which could be the location of the user. In step S2 the processor can then determine the equivalent cell by interpolating the user measurement at the evaluation point from each cell. Alternatively, in step S2 the processor can determine the equivalent cell by estimating signal strength at the evaluation point according to a propagation model. This is discussed in more detail below. As a further alternative, in step S2 the equivalent cell can be determined by using a combination of interpolating the user measurement at the evaluation point from each cell and estimating signal strength at the evaluation point according to the propagation model. The processor could also be configured to determine the equivalent cell by using a geometrical shape to describe interference of the equivalent cell and respective rules for spectrum efficiency. This is also described in more detail below.

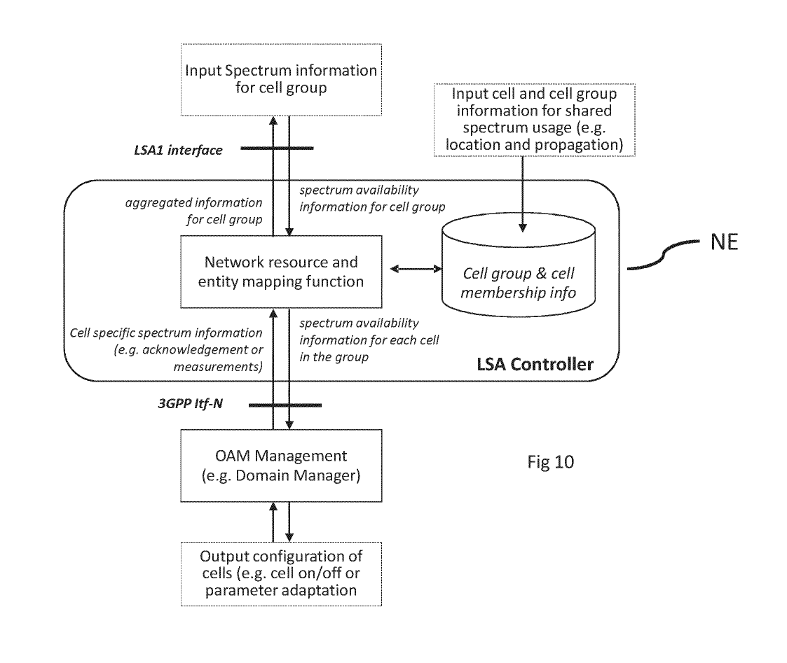

FIG. 4 shows another example of how the network entity NE can operate. The network entity NE can be operatively coupled to the spectrum manager SM via an LSA1 interface and to OAM management via a 3GPP Itf-N interface. This is shown in more detail in FIG. 10. In step S11, an equivalent cell is obtained by the receiver R, which is equivalent to one or more cells of the network to be used as a shared spectrum resource. In step S12 the processor P determines if the shared spectrum resource can be used by the spectrum sharing partner using a characteristic of the equivalent cell. For example, in step 11 the equivalent cell can be obtained from an interference environment of a shared spectrum resource, or by finding a best fit between a geometric shape and an interference map obtained from the one or more cells of the network. In step 12 the processor P can determine an interference map for the equivalent cell. The interference map can then be used in order to determine whether the shared spectrum resource would interfere with a potential spectrum sharing partner, and thus not be suitable for us by that potential spectrum sharing partner.

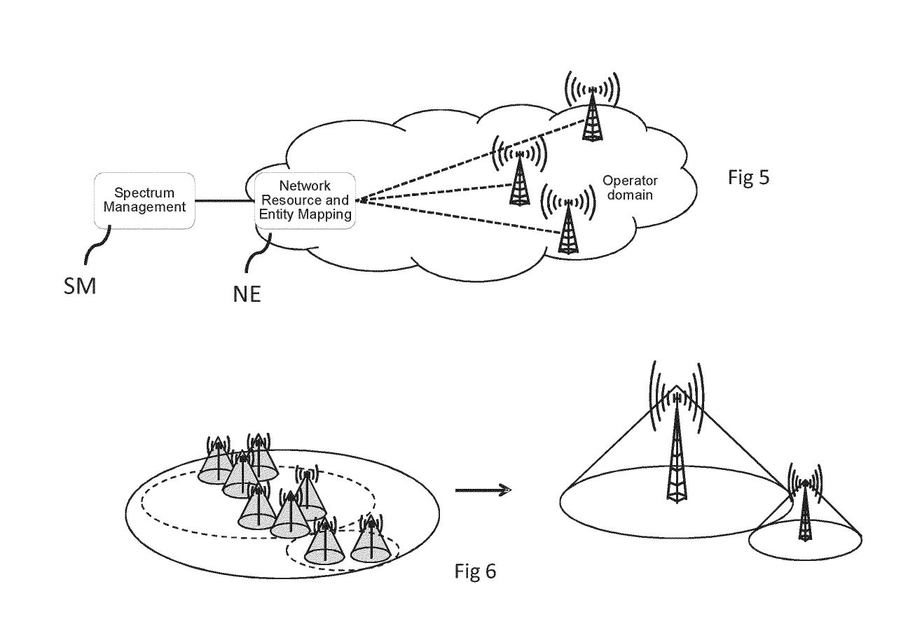

In one example, the network entity NE can include a Network Resource and Entity Mapping function (NREM) located in the operator domain, controlling the data exchange between the network elements forming the cells and the Spectrum Manager SM. This is shown in FIG. 5. The main task of the NREM is to:
hide the real cell layout to the SM by introducing a single cell with a equivalent behavior as the multiple cells forming the network;
translate and split information sent by the SM for the equivalent cell to cell specific information for each cell forming the network;
aggregate and translate cell specific information sent by each cell forming the network to equivalent cell information, which are used to communicate with the SM.

Additional advantages provided by examples of the invention described herein are that that the interference protection, calculated at the SM, does not overlap with 3GPP functions dealing with interference, for example enhanced inter-cell interference coordination (eICIC).

In another example, mapping of the multiple cell network to an equivalent cell is not necessarily performed at the NREM and may be provided as input from a network planning system. FIG. 6 shows the principle for a network that includes 8 base stations/access points BS/AP that are mapped to two equivalent cells.

The calculation of the equivalent cell and the respective mapping of the physical cells can be based on known techniques using interference maps. Interference maps are typically derived from measurements, network planning tools, or a combination of both. To get such measurements, a standardized Minimization of Drive Tests (MDT) method may be used, whenever the shared spectrum resources are available. MDT provides additional location information as well as the measurements. The measurements are the base of calculating the interference map for all physical cells in an area.

In order to cover areas where there are no or not enough valid measurements available, for example due to the absence of users in these areas, the interference map can be estimated with help of well accepted propagation models (such as described in 3GPP TS 36.814). To provide the best results, the selection of the propagation model should be aligned in such a case with the model used by the Spectrum Manager. To additionally allow interference self coordination between the physical cells, the interference map is always based on the worst case scenario. This means that any interference optimizations for the physical cells will not violate the interference map.

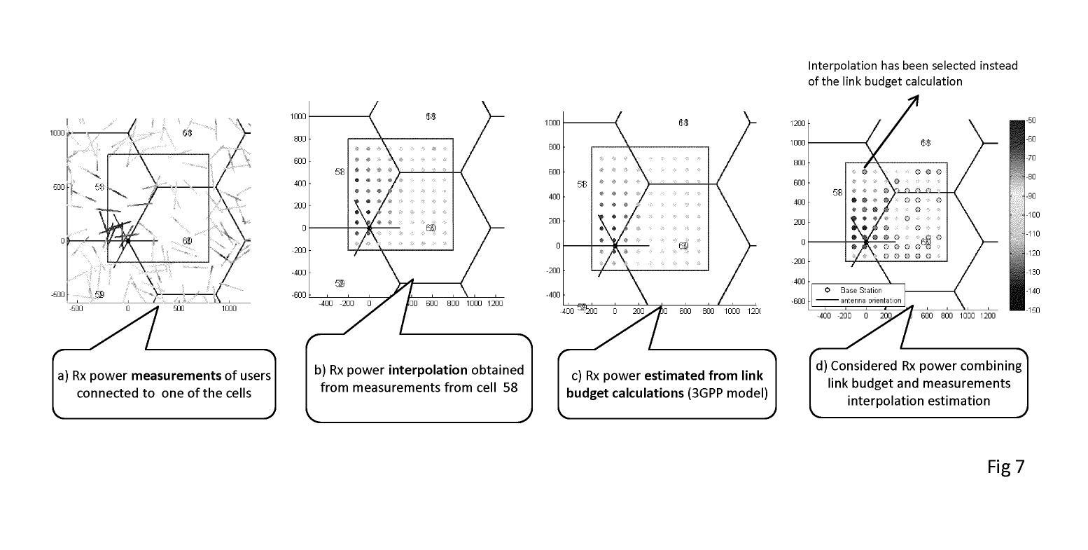

FIG. 7 shows an example where the following steps to obtain the signal strength at the evaluation points defined in the area where shared spectrum are used:
In Step S21, collection of all the user measurements takes place, including locations (Receive power measurements of users connected to one of the cells).
In Step S22, there is interpolation of all user measurements for each cell at the evaluation points.
In Step S23, the signal strength at the evaluation points is estimated according to the propagation models.

In another example, measurement interpolation and the propagation models estimation are combined (Step S24). For each evaluation point, the interpolated value of the measurements is selected when there are enough valid measurements, and the estimation based on the propagation model is selected when there are no measurements, or the measurements are too far from the evaluation point.

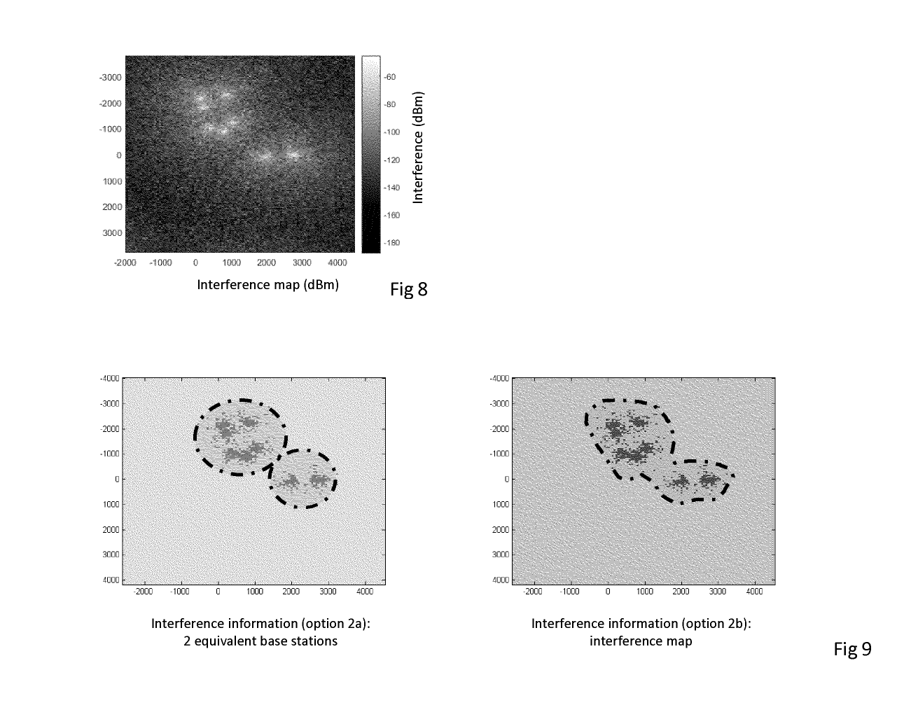

Once the signal strength from each cell at all the evaluation points is obtained, the interference at each evaluation point is found by adding the signal strength from all cells. FIG. 8 shows the interference map corresponding to the example from FIG. 6. As described previously, in order to provide the information about the interference to the Spectrum manager SM, reducing the information to be exchanged and without sharing the detailed network configuration information, the Network Resource and Entity Mapping can provide the interference information through a mapping of the total interference from all the cells that are part of the network.

FIG. 9 shows these two options. In option 2a “support of circles”, the interference information is mapped to two equivalent cells considering the worst case and in the option 2b “support of polygon”, the interference information is mapped to an area where the maximum interference threshold is exceeded.

FIG. 10 shows how the network resource and entity mapping function (NREM) can be implemented in the network entity NE (in this example an LSA Controller) for a dynamic LSA sharing scenario. The NREM in the LSA Controller exchanges spectrum request/response information from the LSA Repository for an equivalent Cell, identified by a unique Equivalent Cell-Id (ECId). The ECId represents a number of cells in a MFCN; i.e., the ECId is equal to a group identifier. The information about the physical cells, identified by the respective Cell-Ids, forming the group with the ECId is provided by an external Network planning system, which is typically available in existing mobile networks.

The Network planning system also provides a location and the respective propagation information for the equivalent cell, as well as configuration parameters for each physical cell. The configuration parameters may include parameter ranges, which can be used for self management of the physical cells. It is also possible to provide multiple sets of configuration parameters for the physical cells that are used to cover different sharing scenario options. Such options are then selected by the NREM based on information received from the LSA Repository.

The information is stored locally at the LSA controller in a database, which provides the information to the NREM. The NREM will receive and send spectrum information for the equivalent cell via the LSA1 interface that connects the LSA Controller with a LSA Repository and communicates via the 3GPP Itf-N interface (northbound interface) with an OAM Management system, e.g. responsible domain manager for the physical cells.

Although the present invention has been described hereinabove with reference to specific embodiments, it is not limited to these embodiments and no doubt further alternatives will occur to the skilled person that lie within the scope of the invention as claimed.

### LIST OF ABBREVIATIONS

ASA Authorized Shared Access

BS Base Station

C Cell

DB Database

GAA Generalized Authorized Access

LC LSA Controller

LLA Licensee-Licensee Agreement

LR LSA Repository

LSA Licensed Shared Access

MDT Minimization of Drive Tests

MNO Mobile Network Operator

NRA National Telecommunications Regulatory Authorities

OAM Operation Administration & Maintenance

OSS Operations Support System

PA Priority Access

RSPG Radio Spectrum Policy Group

SC Spectrum Controller

SMS Spectrum Management System

TVWS TV White Space

UE User Equipment

WISP Wireless Internet Service Provider

1. A method, comprising:
obtaining a property from one or more cells of a communications network; and
determining an equivalent cell equivalent to the one or more cells using said property.

2. The method according to claim 1, wherein the property of the one or more cells is mapped to the equivalent cell.

3. The method according to claim 1, wherein the property is obtained from an evaluation point in the one or more cells.

4. The method according to claim 3, wherein the property includes a user measurement at the evaluation point from each cell of the one or more cells of the network.

5. The method according to claim 4, wherein the user measurement includes location.

6. The method according to claim 4, wherein obtaining comprises collecting the user measurement at the evaluation point from each cell.

7. The method according to claim 4, wherein the determining comprises interpolating the user measurement at the evaluation point from each cell.

8. The method according to claim 3, wherein the determining comprises estimating signal strength at the evaluation point according to a propagation model.

9. The method according to claim 4, wherein the determining comprises a combination of interpolating the user measurement at the evaluation point from each cell and estimating signal strength at the evaluation point according to a propagation model.

10. The method according to claim 1, wherein the determining further comprises using a geometrical shape to describe interference of the equivalent cell.

11. The method according to claim 10, wherein the geometrical shape is used to describe respective rules for spectrum usage.

12. A method, comprising:
obtaining an equivalent cell equivalent to one or more cells of a communications network;
requesting a shared spectrum resource for the equivalent cell; and
determining if the shared spectrum resource can be used by the equivalent cell by using inside and outside characteristics of a geometrical shape representing the equivalent cell.

13. The method according to claim 12, wherein a property of the one or more cells is mapped to the equivalent cell.

14. The method according to claim 12, wherein the obtaining comprises obtaining the equivalent cell from an interference environment of a shared spectrum resource.

15. The method according to claim 12, wherein the obtaining further comprises finding a best fit between the geometric shape and an interference map obtained from the one or more cells of the network.

16. The method according to claim 12, wherein the determining comprises determining an interference map for the equivalent cell.

17. The method according to claim 12, wherein the interference map is used to determine whether the shared spectrum resource would interfere with the spectrum sharing partner.

18. A computer program product embodied on a non-transitory computer-readable medium, said computer program product being configured to run on a processor, wherein the computer program product is configured to control the processor to perform the method of claim 1.

19. An apparatus, comprising:
a receiver configured to obtain a property from one or more cells of a communications network; and
a processor configured use to said property to determine an equivalent cell equivalent to the one or more cells.

20. The apparatus according to claim 19, wherein the receiver is configured to receive the property from an evaluation point in the one or more cells.

21. The apparatus according to claim 20, wherein the receiver is configured to receive a user measurement at the evaluation point from each cell of the one or more cells of the network.

22. The apparatus according to claim 21, wherein the user measurement includes location.

23. The apparatus according to claim 21, wherein the processor is configured to determine the equivalent cell by interpolating the user measurement at the evaluation point from each cell.

24. The apparatus according to claim 20, wherein the processor is configured to determine the equivalent cell by estimating signal strength at the evaluation point according to a propagation model.

25. The apparatus according to claim 21, wherein the processor is configured to determine the equivalent cell by using a combination of interpolating the user measurement at the evaluation point from each cell and estimating signal strength at the evaluation point according to a propagation model.

26. The apparatus according to claim 23, wherein the processor is configured to determine the equivalent cell by using a geometrical shape to describe interference of the equivalent cell.

27. The apparatus according claim 26, wherein the processor is further configured to determine respective rules for spectrum usage by using said geometrical shape.

28. An apparatus, comprising:
a receiver configured to obtain an equivalent cell equivalent to one or more cells of a communications network;
a transmitter configured to request a shared spectrum resource for the equivalent cell; and
a processor configured to determine if the shared spectrum resource can be used by the equivalent cell by using inside and outside characteristics of a geometrical shape representing the equivalent cell.

29. The apparatus according to claim 28, wherein the receiver is configured to obtain the equivalent cell from an interference environment of a shared spectrum resource.

30. The apparatus according to claim 29, wherein the receiver is further configured to obtain the equivalent cell by finding a best fit between the geometric shape and an interference map obtained from the one or more cells of the network.

31. The apparatus according to claim 28, wherein the processor is configured to determine an interference map for the equivalent cell.

32. The apparatus according to claim 31, wherein the processor is further configured to use the interference map in order to determine whether the shared spectrum resource would interfere with the spectrum sharing partner.

33. The apparatus according to claim 19, wherein the apparatus comprises a network entity.
